(19) United States
(12) Patent Application Publication
(10) Pub. No.: US 2023/0250024 A1
(43) Pub. Date: Aug. 10, 2023

(54) DIELECTRIC MATERIAL, MULTILAYER CERAMIC ELECTRONIC DEVICE, MANUFACTURING METHOD OF DIELECTRIC MATERIAL, AND MANUFACTURING METHOD OF MULTILAYER CERAMIC ELECTRONIC DEVICE

(71) Applicant: TAIYO YUDEN CO., LTD., Tokyo (JP)

(72) Inventors: Yuta FUSE, Takasaki-shi (JP); Yuji TSUSHIMA, Takasaki-shi (JP)

(21) Appl. No.: 18/163,206

(22) Filed: Feb. 1, 2023

(30) Foreign Application Priority Data
Feb. 10, 2022 (JP) 2022-019669

(51) Int. Cl. C04B 35/468; C04B 41/00; H01G 4/12; H01G 4/33

(52) U.S. Cl. CPC C04B 35/468; C04B 41/0072; H01G 4/1218; H01G 4/33; C04B 2235/75; C04B 2235/6562

(57) ABSTRACT

A dielectric material includes a main component including barium titanate, a first additive containing zirconium in an amount of 2 at % or more and 10 at % or less with respect to titanium of the barium titanate, a second additive containing 0.2 at % or more and 3.5 at % or less of europium with respect to titanium of the barium titanate, rare earth elements other than europium being less than europium, a third additive containing 0.5 at % or more and 4.5 at % or less of manganese with respect to titanium of the barium titanate, and a fourth additive containing at least one of strontium and calcium in an amount of 0.1 at % or more and 3 at % or less with respect to titanium in the barium titanate.

### CROSS-REFERENCE TO RELATED APPLICATION

This application is based upon and claims the benefit of priority of the prior Japanese Patent Application No. 2022-019669, filed on Feb. 10, 2022, the entire contents of which are incorporated herein by reference.

### FIELD

A certain aspect of the present disclosure relates to a dielectric material, a multilayer ceramic electronic device, a manufacturing method of the dielectric material and a manufacturing method of the multilayer ceramic electronic device.

### BACKGROUND

Multilayer ceramic capacitors are used to eliminate noise in high-frequency communication systems typified by mobile phones. Multilayer ceramic capacitors are also used in electronic circuits related to human life, such as in-vehicle electronic control devices. Since multilayer ceramic capacitors are required to have high reliability, techniques for improving the reliability have been disclosed (for example, see Japanese Patent Application Publication No. 2017-114751, Japanese Patent Application Publication No. 2018-90458, Japanese Patent Application Publication No. 2019-131438, Japanese Patent Application Publication No. 2016-169130, and Japanese Patent Application Publication No. 2015-187969).

### SUMMARY OF THE INVENTION

According to a first aspect of the embodiments, there is provided a dielectric material including: a main component including barium titanate; a first additive containing zirconium in an amount of 2 at % or more and 10 at % or less with respect to titanium of the barium titanate; a second additive containing 0.2 at % or more and 3.5 at % or less of europium with respect to titanium of the barium titanate, rare earth elements other than europium being less than europium; a third additive containing 0.5 at % or more and 4.5 at % or less of manganese with respect to titanium of the barium titanate; and a fourth additive containing at least one of strontium and calcium in an amount of 0.1 at % or more and 3 at % or less with respect to titanium in the barium titanate.

According to a second aspect of the embodiments, there is provided a multilayer ceramic electronic device including: a plurality of dielectric layers including a main component including barium titanate, a first additive containing zirconium in an amount of 2 at % or more and 10 at % or less with respect to titanium of the barium titanate, a second additive containing 0.2 at % or more and 3.5 at % or less of europium with respect to titanium of the barium titanate, rare earth elements other than europium being less than europium, a third additive containing 0.5 at % or more and 4.5 at % or less of manganese with respect to titanium of the barium titanate, and a fourth additive containing at least one of strontium and calcium in an amount of 0.1 at % or more and 3 at % or less with respect to titanium in the barium titanate; a plurality of internal electrode layers each of which is sandwiched by each two of the plurality of dielectric layers; and external electrodes that are electrically connected to the plurality of internal electrode layers.

According to a third aspect of the embodiments, there is provided a manufacturing method of a dielectric material including: forming a ceramic green sheet including a main component including barium titanate, a first additive containing zirconium in an amount of 2 at % or more and 10 at % or less with respect to titanium of the barium titanate, a second additive containing 0.2 at % or more and 3.5 at % or less of europium with respect to titanium of the barium titanate, rare earth elements other than europium being less than europium, a third additive containing 0.5 at % or more and 4.5 at % or less of manganese with respect to titanium of the barium titanate, and a fourth additive containing at least one of strontium and calcium in an amount of 0.1 at % or more and 3 at % or less with respect to titanium in the barium titanate; and firing the ceramic green sheet at a temperature rising rate of 5000° C./h or more and 10000° C./h or less.

According to a fourth aspect of the embodiments, there is provided a manufacturing method of a multilayer ceramic electronic device including: forming a plurality of ceramic green sheets including a main component including barium titanate, a first additive containing zirconium in an amount of 2 at % or more and 10 at % or less with respect to titanium of the barium titanate, a second additive containing 0.2 at % or more and 3.5 at % or less of europium with respect to titanium of the barium titanate, rare earth elements other than europium being less than europium, a third additive containing 0.5 at % or more and 4.5 at % or less of manganese with respect to titanium of the barium titanate, and a fourth additive containing at least one of strontium and calcium in an amount of 0.1 at % or more and 3 at % or less with respect to titanium in the barium titanate; forming an internal electrode pattern on each of the ceramic green sheets; forming a multilayer structure by stacking the plurality of ceramic green sheets on which the internal electrode is formed; and forming a plurality of dielectric layers and a plurality of internal electrode layers by firing the multilayer structure at a temperature rising rate of 5000° C./h or more and 10000° C./h or less.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4A schematically illustrates a core-shell grain;

FIG. 4B schematically illustrates a cross section of a dielectric layer;

FIG. 5 is a flowchart of a method of manufacturing a multilayer ceramic capacitor; and

FIG. 6 schematically illustrates a SEM image of cross section of dielectric layers and internal electrode layers in a capacity section of Example 1;

FIG. 7 schematically illustrates a TEM image of a dielectric layer in a capacity section;

FIG. 8A illustrates measurement results of TEM-EDS analysis of a shell portion;

FIG. 8B illustrates measurement results of TEM-EDS analysis for a core portion; and

FIG. 9 is a SEM image of a multilayer cross-section of a dielectric layer and an internal electrode layer in a capacitor section in Comparative Example 11.

### DETAILED DESCRIPTION

For the dielectric of multilayer ceramic capacitors, sintered bodies with a core-shell structure, in which barium titanate is used as a core and the core is surrounded by a shell in which various additives are solid-dissolved, have been used. This is because excellent capacity-temperature characteristics can be obtained, and a material coexisting with a stable fine structure can be obtained even in the firing process. Magnesium (Mg) is a typical additive that constitutes the shell. However, magnesium is a simple acceptor that does not fluctuate in valence and generates oxygen vacancies that are known to adversely affect the reliability of multilayer ceramic capacitors because of electrically neutral conditions. Therefore, there is a problem that the reliability cannot be sufficiently high.

Next, for high-reliability applications, there is a demand for multilayer ceramic capacitors that can be used at high temperatures up to 150° C. However, barium titanate, which is the main component of the dielectric layer, has a Curie point of about 125° C. And, the capacity of the barium titanate greatly decreases at temperatures above the Curie point. The temperature characteristic X8R (Capacity change rate from −55° C. to 150° C. is within ±15% based on 25° C. capacity) of the EIA standard cannot be satisfied without special measures. As an improvement measure, there is a method to satisfy X8R by adding ytterbium (Yb) to the dielectric layer to shift the Curie point to the high temperature side. Since ytterbium acts as an acceptor, ytterbium is not reliable enough for high-reliability applications like magnesium mentioned above. There is also a method of mixing BaTi₂O₅ (470° C.), which has a high Curie point, with BaTiO₃, but BaTi₂O₅ has a low dielectric constant at room temperature and cannot exhibit high capacity.

Hereinafter, an exemplary embodiment will be described with reference to the accompanying drawings.

### Exemplary Embodiment

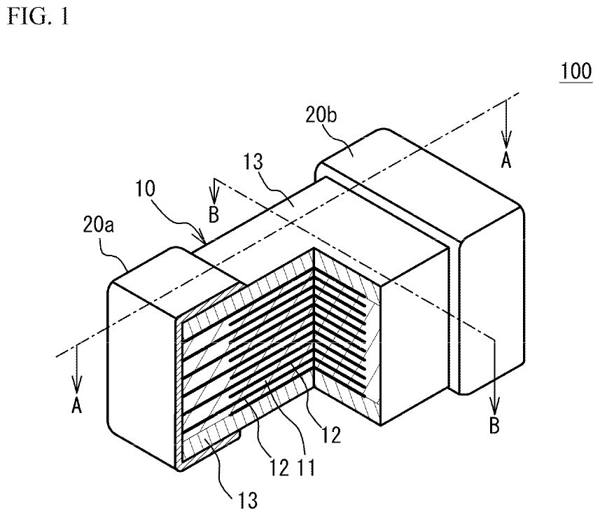

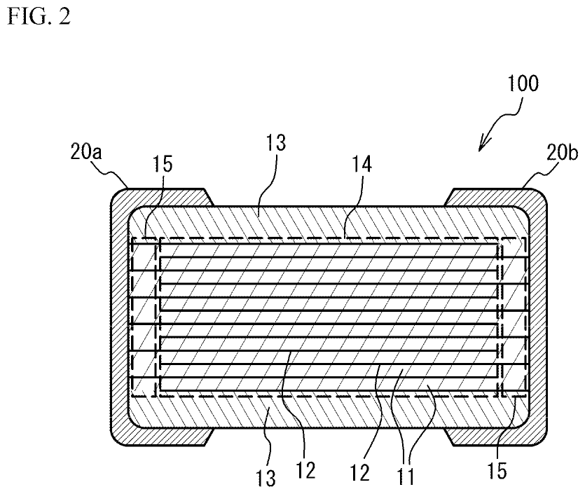

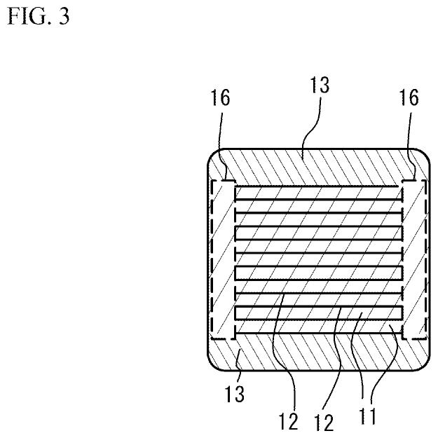

FIG. 1 illustrates a perspective view of a multilayer ceramic capacitor 100 in accordance with an embodiment, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes a multilayer chip 10 having a rectangular parallelepiped shape, and external electrodes 20a and 20b that are respectively provided on two edge faces of the multilayer chip 10 facing each other. Among four faces other than the two edge faces of the multilayer chip 10, two faces other than the top face and the bottom face in the stack direction are referred to as side faces. Each of the external electrodes 20a and 20b extends to the top face and the bottom face in the stack direction and the two side faces of the multilayer chip 10. However, the external electrodes 20a and 20b are spaced from each other.

The multilayer chip 10 has a structure designed to have dielectric layers 11 and internal electrode layers 12 alternately stacked. The dielectric layer 11 contains a ceramic material acting as a dielectric material. End edges of the internal electrode layers 12 are alternately exposed to a first edge face of the multilayer chip 10 and a second edge face of the multilayer chip 10 that is different from the first edge face. The external electrode 20a is provided on the first edge face. The external electrode 20b is provided on the second edge face. Thus, the internal electrode layers 12 are alternately electrically connected to the external electrode 20a and the external electrode 20b. Accordingly, the multilayer ceramic capacitor 100 has a structure in which a plurality of the dielectric layers 11 is stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the cover layer 13 may or may not necessarily have the same composition as the dielectric layer 11. It should be noted that the structure is not limited to that illustrated in FIG. 1 to FIG. 3 as long as the internal electrode layers 12 are exposed on two different surfaces and electrically connected to different external electrodes.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The internal electrode layer 12 is mainly composed of a base metal such as nickel (Ni), copper (Cu), or tin (Sn). The internal electrode layer 12 may be composed of a noble metal such as platinum (Pt), palladium (Pd), silver (Ag), or gold (Au) or alloy including one or more of them. The thickness of the internal electrode layer 12 is, for example, 0.1 μm or more and 3 μm or less, 0.1 μm or more and 1 μm or less, or 0.1 μm or more and 0.5 μm or less.

The dielectric layer 11 is a dielectric material. The dielectric layer 11 is mainly composed of a ceramic material having a perovskite structure expressed by a general formula ABO₃. The perovskite structure includes ABO_{3-α} a having an off-stoichiometric composition. In the embodiment BaTiO₃ (barium titanate) is used as the ceramic material. The thickness of the dielectric layer 11 is, for example, 0.2 μm or more and 10 μm or less, 0.2 μm or more and 5 μm or less, or 0.2 μm or more and 2 μm or less.

As illustrated in FIG. 2, the section where the internal electrode layer 12 connected to the external electrode 20a faces the internal electrode layer 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 3, in the multilayer chip 10, the section from each of the two side faces of the multilayer chip 10 to the internal electrode layers 12 is referred to as a side margin 16. That is, the side margin 16 is a section that covers each of the edges, extending toward the respective side faces of the multilayer structure, of the stacked internal electrode layers 12. The side margin 16 is a section where no capacity is generated.

The dielectric layer 11 of the capacity section 14 contains barium titanate as a main component, a first additive containing zirconium (Zr), a second additive containing europium (Eu), a third additive containing manganese (Mn) and a fourth additive containing at least one of strontium or calcium.

In the capacity section 14 of the multilayer ceramic capacitor 100, when at least a part of the barium titanate crystal grains (dielectric crystals) included in the dielectric layer 11 has a core-shell structure, the dielectric layer 11 in the capacity section 14 has a high dielectric constant, excellent temperature characteristics, and a stable microstructure.

Magnesium is a typical additive that makes up the shell. However, magnesium is a simple acceptor whose valence does not fluctuate, and forms a solid solution in barium titanate of the dielectric layer 11 to generate oxygen vacancies, which may limit reliability.

(Regarding the first additive) Therefore, in the present embodiment, the dielectric layer 11 in the capacity section 14 contains the first additive, so that at least a part of the barium titanate crystal grains contained in the dielectric layer 11 has the core-shell structure having a core portion containing barium titanate as a main component and a shell portion of a zirconium (Zr) diffusion layer. Note that the main component of the shell is barium titanate.

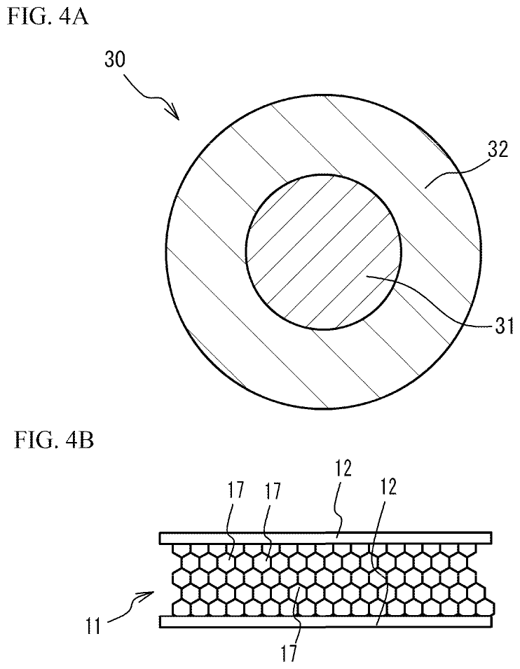

As illustrated in FIG. 4A, a core-shell grain 30 includes a substantially spherical core portion 31 and a shell portion 32 that surrounds and covers the core portion 31. The core portion 31 is a crystal portion in which the additive compound is not solid-dissolved or the amount of the additive compound in solid-solution is small. The shell portion 32 is a crystal portion in which the additive compound is solid-solved and has a concentration of the additive compound higher than that of the core portion 31. In this embodiment, the zirconium concentration in the shell portion 32 is higher than the zirconium concentration in the core portion 31. Alternatively, zirconium is diffused in the shell portion 32 and zirconium is not diffused in the core portion 31.

FIG. 4B is a schematic cross-sectional view of the dielectric layer 11. As illustrated in FIG. 4B, the dielectric layer 11 comprises a plurality of crystal grains 17 of the main component ceramic. At least a part of these crystal grains 17 are the core-shell grains 30 described in FIG. 4A. By covering the core portion 31 with the shell portion 32 having high zirconium concentration and high reduction resistance, it is possible to obtain a highly reliable material having a stable structure while maintaining a high dielectric constant.

When zirconium diffuses into barium titanate and forms a solid solution, the Curie temperature of barium titanate decreases. When the thickness of the diffusion layer of zirconium increases excessively, the change rate of the capacity at high temperature increases. In this case, there is a risk that the multilayer ceramic capacitor 100 will not satisfy the X8R characteristics. In general, zirconium diffuses into barium titanate as a solid solution and causes rapid grain growth. Therefore, it is difficult to realize X8R characteristics by limiting the thickness of the diffusion layer to suppress grain growth. For example, when the heating rate in the firing step is about 10° C./h, the diffusion of the rare earth elements is excessively promoted and all solid-solution grains are formed. In this case, solid solution of zirconium and rare earth elements progresses. Therefore, a long life can be obtained, but the dielectric constant tends to be low, the sintering stability is lowered, and the temperature characteristics of capacity tend to be poor. In the present embodiment, the zirconium diffusion length is limited and the zirconium concentration in the shell portion 32 is higher than that in the core portion 31, so the multilayer ceramic capacitor 100 satisfies the X8R characteristics.

When the amount of zirconium in the dielectric layer 11 of the capacity section 14 is small, the core-shell structure having a core portion with a low zirconium concentration and a shell portion with a high zirconium concentration cannot be maintained, causing localized abnormal growth. In this case, a long life is not obtained, and X8R characteristics may not be necessarily obtained either. Therefore, in the present embodiment, a lower limit is set for the amount of zirconium with respect to titanium in barium titanate, which is the main component of the dielectric layer 11 (the amount of zirconium (at %) when titanium is 100 at %). Specifically, the amount of zirconium with respect to titanium is set to 2 at % or more. In this case, the grain size of the crystal grains 17 becomes substantially uniform, and a stable core-shell structure having an element distribution in which high-concentration Zr is arranged in the shell portion 32 can be formed. The amount of zirconium with respect to titanium is preferably 2 at % or more, more preferably 4 at % or more.

On the other hand, when the amount of zirconium in the dielectric layer 11 of the capacity section 14 is large, the dielectric constant of the dielectric layer 11 will be low (for example, 1500 or less) and the X8R characteristics may not be necessarily satisfied. Therefore, in the present embodiment, an upper limit is set for the amount of zirconium with respect to titanium. Specifically, in the dielectric layer 11 of capacity section 14, the amount of zirconium with respect to titanium is set to 10 at % or less. Thereby, a sufficient dielectric constant can be obtained. The amount of zirconium with respect to titanium is preferably 8 at % or less, more preferably 6 at % or less.

(Regarding the second additive) However, by adding zirconium to the dielectric layer 11, the lattice constant of the crystal of barium titanate is expanded. And a larger amount of rare earth elements such as holmium (Ho), dysprosium (Dy), and yttrium (Y), which are the key to long life, are solid-solved in the Ti site than in the Ba site, resulting in an excess of acceptors, which limits the life improvement effect.

Therefore, the present inventors have investigated rare earth elements with a large ionic radius that are easily substituted and solid-solved in the Ba site of barium titanate. As a result, the present inventors have found that the life is improved by about one order of magnitude compared to the rare earth element such as holmium, dysprosium, and yttrium. The reason why the addition of europium improves the lifetime is not completely clear. Europium is stable at 2 and 3 valences. The valence of europium fluctuate between 2 and 3. Europium has the largest ionic radius in the rare earth elements which are stable under divalence condition. Therefore, europium is selectively substituted and solid-solved at the Ba site due to the ionic radius. Rare earth elements other than europium are stable at trivalence and unstable at divalence.

Table 1 shows the ionic radii of the six coordination of each rare earth element. The source of Table 1 is “RD Shannon, Acta Crystallogr., A32, 751 (1976)”.

TABLE 1

IONIC RADIUS(Å)

| | | COORDINATION | COORDINATION |
|---|---|---|---|
| | VALENCE | NUMBER IS 6 | NUMBER IS 12 |
| Ba | +2 | | 1.610 |
| Ti | +4 | 0.605 | |
| Eu | +2 | 1.170 | |
| Dy | +2 | 1.070 | |
| La | +3 | 1.032 | |
| Tm | +2 | 1.030 | |
| Yb | +2 | 1.020 | |
| Ce | +3 | 1.010 | |
| Pr | +3 | 0.990 | |
| Nd | +3 | 0.983 | |
| Pm | +3 | 0.970 | |
| Sm | +3 | 0.958 | |
| Eu | +3 | 0.947 | |
| Gd | +3 | 0.938 | |
| Tb | +3 | 0.923 | |
| Dy | +3 | 0.912 | |
| Ho | +3 | 0.901 | |
| Y | +3 | 0.900 | |
| Er | +3 | 0.890 | |
| Tm | +3 | 0.880 | |
| Yb | +3 | 0.868 | |
| Lu | +3 | 0.861 | |
| Sc | +3 | 0.745 | |

Europium also becomes a solid solution in the shell portion 32 rather than in the core portion 31. Therefore, the europium concentration in the shell portion 32 is higher than the europium concentration in the core portion 31.

In the dielectric layer 11 of the capacity section 14, when the amount of europium in barium titanate, which is the main component of the dielectric layer 11 (the amount of europium (at %) when the amount of titanium is 100 at %) is too small, long life may not be necessarily obtained. Therefore, in the present embodiment, a lower limit is set for the amount of europium with respect to titanium. Specifically, in the dielectric layer 11 of the capacity section 14, the amount of europium with respect to titanium is set to 0.2 at % or more. The amount of europium with respect to titanium is preferably 0.5 at % or more, more preferably 1 at % or more.

On the other hand, when the amount of europium with respect to titanium in the dielectric layer 11 of the capacity section 14 is too large, the dielectric layer 11 may become a semiconductor and a long life may not be necessarily obtained. Therefore, in the present embodiment, an upper limit is set for the amount of europium with respect to titanium. Specifically, in the dielectric layer 11 of the capacity section 14, the amount of europium with respect to titanium is set to 3.5 at % or less. The amount of europium with respect to titanium is preferably 3 at % or less, more preferably 2 at % or less.

When the amount of divalent europium in the europium added to the dielectric layer 11 of the capacity section 14 is small, there is a risk that a sufficiently long life cannot be obtained. Therefore, it is preferable to set a lower limit on the amount of divalent europium in the europium in the dielectric layer 11 of the capacity section 14. For example, in the dielectric layer 11 of the capacity section 14, it is preferable that the amount of divalent europium in the total europium is 21% or more. It is more preferable that the amount of divalent europium in the total europium is 26% or more.

In order to increase the ratio of divalent europium, it is required to reduce a large amount of trivalent europium. However, grain growth may occur in the dielectric layer 11 during the reduction of much trivalent europium in the annealing step for reduction to divalent europium. The grain growth may shorten the life of the dielectric layer 11. Therefore, when grain growth occurs in the dielectric layer 11, the life-reducing effect due to the grain growth may cancel out the life-improving effect of the valence of europium, and the grain growth makes it impossible for the internal electrode layers 12 to maintain their structure. In addition, a short circuit may occur. Therefore, it is preferable to set an upper limit on the amount of divalent europium in the europium in the dielectric layer 11 of the capacity section 14. For example, in the dielectric layer 11 of the capacity section 14, it is preferable that the amount of divalent europium in the total europium is 80% or less. It is more preferable that the amount of divalent europium in the total europium is 70% or less. It is still more preferable that the amount of divalent europium in the total europium is 59% or less.

(Regarding the third additive) However, a part of europium may become trivalent and be solid-solved in the Ba site, becoming a donor and deteriorating the insulating properties. The present inventors have found that co-doping with manganese (Mn), which has the function of reducing excess electrons, is effective against the deterioration of the insulating properties. Manganese not only enhances the insulating properties, but also increases the valence by performing a re-oxidation treatment, reduces oxygen defects, and can further improve the life.

In the dielectric layer 11 of the capacity section 14, when the amount of manganese in barium titanate, which is the main component of the dielectric layer 11 (the amount of manganese (at %) when the amount of titanium is 100 at %) is too small, there is a shortage of acceptors and there is a risk that a long life cannot be obtained because the dielectric layer 11 becomes a semiconductor. Therefore, in the present embodiment, a lower limit is set for the amount of manganese with respect to titanium. Specifically, in the dielectric layer 11 of the capacity section 14, the amount of manganese with respect to titanium is set to 0.5 at % or more. The amount of manganese with respect to titanium is preferably 0.5 at % or more, more preferably 1 at % or more.

On the other hand, in the dielectric layer 11 of the capacity section 14, when the amount of manganese with respect to titanium is large, the amount of oxygen vacancies may be excessive due to the excessive amount of acceptors, and the life may be shortened. Therefore, in the present embodiment, an upper limit is set for the amount of manganese with respect to titanium. Specifically, in the dielectric layer 11 of the capacity section 14, the amount of manganese with respect to titanium is set to 4.5 at % or less. The manganese amount with respect to titanium is preferably 3 at % or less, more preferably 2 at % or less.

(Regarding the fourth additive) The present inventors have found that the insulation property of the dielectric layer 11 is improved and the life of the multilayer ceramic capacitor 100 is improved by adding at least one of strontium and calcium to the dielectric layer 11 in the capacity section 14 in addition to manganese.

As shown in Table 1, Ba²⁺ has an ionic radius of 1.61 Å with 12 coordinates. In contrast, Ca²⁺ has an ionic radius of 1.34 Å with 12 coordinates. Sr²⁺ has an ionic radius of 1.4 Å with 12 coordinates. Thus, strontium and calcium have an ionic radius close to barium. Therefore, strontium and calcium are generally thought to form a solid solution in the Ba site of barium titanate, and are unlikely to act as acceptors. For this reason, it is thought that divalent strontium and divalent calcium are solid-solved partly in the Ba site instead of europium, thereby reducing the solid-solution ratio of trivalent europium and improving the insulation. On the other hand, it is thought that the reason of the improvement of the life is that the lattice shrinks due to the solid solution of divalent strontium ions and divalent calcium ions, which are smaller than the divalent Ba ion radius, into the barium titanate, the movement of oxygen vacancies is restricted, and insulation destruction becomes difficult to occur.

In the dielectric layer 11 of the capacity section 14, when the amount of strontium in barium titanate, which is the main component of the dielectric layer 11 (the amount of strontium (at %) when the amount of titanium is 100 at %) is small, there is a possibility that the insulation of the dielectric layer 11 cannot be improved. Therefore, in the present embodiment, a lower limit is set for the amount of strontium with respect to titanium. Specifically, in the dielectric layer 11 of the capacity section 14, the amount of strontium with respect to titanium is set to 0.1 at % or more. The amount of strontium with respect to titanium is preferably 0.2 at % or more, more preferably 0.5 at % or more.

On the other hand, when the amount of strontium with respect to titanium in the dielectric layer 11 of the capacity section 14 is large, grain growth may proceed and the life may be shortened. Therefore, in the present embodiment, an upper limit is set for the amount of strontium with respect to titanium. Specifically, in the dielectric layer 11 of the capacity section 14, the amount of strontium with respect to titanium is set to 3 at % or less. The amount of strontium with respect to titanium is preferably 2 at % or less, more preferably 1 at % or less.

In the dielectric layer 11 of the capacity section 14, when the amount of calcium in barium titanate, which is the main component of the dielectric layer 11 (the amount of calcium (at %) when the amount of titanium is 100 at %) is small, there is a possibility that the insulation of the dielectric layer 11 cannot be improved. Therefore, in the present embodiment, a lower limit is set for the amount of calcium with respect to titanium. Specifically, in the dielectric layer 11 of the capacity section 14, the amount of calcium with respect to titanium is set to 0.1 at % or more. The amount of calcium with respect to titanium is preferably 0.2 at % or more, more preferably 0.5 at % or more.

On the other hand, in the dielectric layer 11 of the capacity section 14, when the amount of calcium with respect to titanium is large, grain growth may proceed and the life may be shortened. Therefore, in the present embodiment, an upper limit is set for the amount of calcium with respect to titanium. Specifically, in the dielectric layer 11 of the capacity section 14, the amount of calcium with respect to titanium is set to 3 at % or less. The amount of calcium to titanium is preferably 2 at % or less, more preferably 1 at % or less.

In addition, when additives such as zirconium and manganese are solid-solved in barium titanate, the Curie temperature of barium titanate shifts to the low temperature side lower than 125° C. and the capacity change rate at high temperatures may deteriorate. On the other hand, in the present embodiment, since the Curie point shifts to a higher temperature side (for example, 130° C.) higher than 125° C., deterioration of the capacity change rate at high temperatures is suppressed and the multilayer ceramic capacitor 100 satisfies the X8R characteristics. The reason why the Curie point shifts to the high temperature side has not been completely elucidated. However, it is thought that the Curie point shifts because internal stress occurs between the core portion 31 in which the crystal lattice has contracted due to solid-solution of a part of europium in the core portion 31 beyond the shell portion 32, and the shell portion 32 in which the crystal lattice is expanded by adding zirconium at a high concentration.

Next, when the amount of the rare earth element other than europium added to the dielectric layer 11 of the capacity section 14 is too large, the life improvement effect of europium may be weakened and sufficient life may not be necessarily obtained. Therefore, it is preferable to set an upper limit for the amount of rare earth elements other than europium. Specifically, in the dielectric layer 11 of the capacity section 14, the atomic concentration of rare earth elements other than europium is preferably lower than the atomic concentration of europium. When there are multiple types of rare earth elements other than europium, the total atomic concentration of the multiple types of rare earth elements is preferably lower than the atomic concentration of europium.

As described above, according to the present embodiment, the dielectric layer 11 in the capacity section contains barium titanate as the main component, and contains the first additive containing zirconium in an amount of 2 at % or more and 10 at % or less with respect to titanium in the barium titanate, the second additive containing 0.2 at % or more and 3.5 at % or less of europium with respect to titanium of barium titanate, the third additive containing 0.5 at % or more and 4.5 at % or less of manganese with respect to titanium of barium titanate, the fourth additive containing at least one of strontium and calcium in an amount of 0.1 at % or more and 3 at % or less with respect to titanium of barium titanate. Therefore, long life and excellent capacity temperature characteristics are achieved.

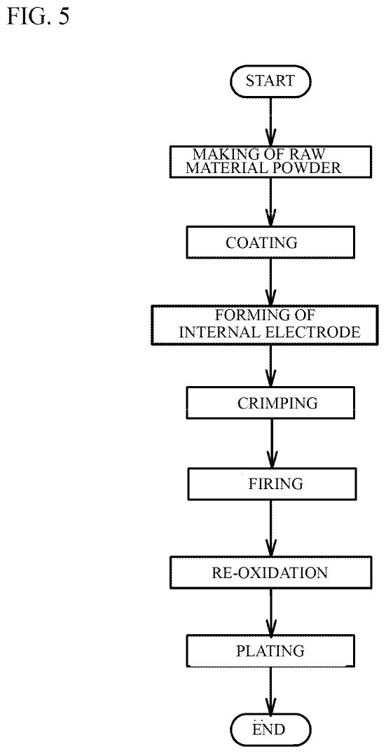

Next, the manufacturing method of the multilayer ceramic capacitor 100 will be described. FIG. 5 is a flowchart of the manufacturing method of the multilayer ceramic capacitor 100.

### Making of Raw Material Powder

A dielectric material for forming the dielectric layer 11 is prepared. The A site element and the B site element contained in the dielectric layer 11 are contained in the dielectric layer 11 typically in the form of a sintered compact of ABO₃ particles. For example, BaTiO₃ is a tetragonal compound having a perovskite structure, and exhibits high dielectric constant. This BaTiO₃ can be obtained typically by reacting a titanium raw material such as titanium dioxide with a barium raw material such as barium carbonate to synthesize barium titanate. Various methods have been known as a synthesizing method of ceramic constituting the dielectric layer 11. For example, the solid phase method, the sol-gel method, the hydrothermal method, and the like are known. Any one of the above methods can be employed in the present embodiment.

Additive compound is added to the resulting ceramic powder in accordance with purposes. The additive compound may be an oxide of zirconium, magnesium, manganese, strontium, calcium, vanadium (V), chromium (Cr) or europium, or an oxide of cobalt (Co), nickel, lithium (Li), boron (B), sodium (Na), potassium (K) or Si (silicon), or glass. If necessary, an oxide of a rare earth element other than europium may be added. The rare earth element is such as scandium (Sc), yttrium, lanthanum (La), cerium (Ce), praseodymium (Pr), neodymium (Nd), promethium (Pm), samarium (Sm), gadolinium (Gd), terbium (Tb), dysprosium, holmium, erbium (Er), thulium (Tm), ytterbium (Yb), or lutetium (Lu).

For example, a ceramic raw material powder is wet-mixed with a compound containing an additive compound, dried and pulverized to prepare a ceramic material. For example, the ceramic material obtained as described above may be pulverized to adjust the particle size, or combined with a classification process to adjust the particle size. A dielectric material is obtained by the above steps. In the dielectric material, barium titanate has an amount of zirconium with respect to titanium of 2 at % or more and 10 at % or less, an amount of europium with respect to titanium of 0.2 at % or more and 3.5 at % or less, and an amount of manganese with respect to titanium of 0.5 at % or more. 0.5 at % or less, and at least one of the strontium content and the calcium with respect to titanium of 0.1 at % or more and 3 at % or less.

### Coating Process

Next, a binder such as polyvinyl butyral (PVB) resin, an organic solvent such as ethanol or toluene, and a plasticizer are added to the resulting dielectric material and wet-blended. With use of the resulting slurry, a strip-shaped ceramic green sheet with a thickness of, for example, 0.5 μm or more is painted on a base material by, for example, a die coater method or a doctor blade method, and then dried.

### Forming of Internal Electrode

Next, an internal electrode layer pattern is formed on the surface of the ceramic green sheet by printing a metal conductive paste for forming the internal electrode with use of screen printing or gravure printing. The metal conductive paste for forming the internal electrode contains an organic binder. A plurality of internal electrode layer patterns are alternately exposed to a pair of external electrodes. Ceramic particles are added as a co-material to the metal conductive paste. The main component of the ceramic particles is not particularly limited, but is preferably the same as the main component ceramic of the dielectric layer 11. For example, BaTiO₃ of which an average grain diameter is 50 nm or less may be evenly dispersed.

### Crimping Process

After that, the ceramic green sheet on which the internal electrode layer pattern is printed is stamped into a predetermined size, and a predetermined number (for example, 100 to 1000) of stamped ceramic green sheets are stacked while the base material is peeled so that the internal electrode layers 12 and the dielectric layers 11 are alternated with each other and the end edges of the internal electrode layers 12 are alternately exposed to both edge faces in the length direction of the dielectric layer so as to be alternately led out to a pair of external electrodes of different polarizations. Cover sheets to be the cover layers 13 are crimped on the upper face and the lower face of the stacked ceramic green sheets in the stacking direction. And, the resulting multilayer structure is cut into a predetermined chip size (for example, 1.0 mm×0.5 mm).

### Firing Process

The binder is removed from the resulting ceramic multilayer structure in N₂ atmosphere. After that, Ni paste to be the base layer of the external electrodes 20a and 20b is painted by a dipping method. The resulting ceramic multilayer structure is fired in a reducing atmosphere with an oxygen partial pressure of 10⁻¹² to 10⁻⁹ MPa in a temperature range of 1160° C. to 1280° C. for 5 minutes to 10 hours.

It should be noted that when the rate of temperature rise is set to a slow rate of about 10° C./h, diffusion of the rare earth element and zirconium is promoted in the dielectric material barium titanate, and solid solution grains are formed. In this case, although a long life can be obtained, the dielectric constant tends to be low, and the sintering stability and capacity-temperature characteristics tend to be poor. Therefore, in the present embodiment, the temperature increase rate is set to 5000° C./h or more and 10000° C./h or less (for example, 6000° C./h) to suppress the diffusion of zirconium and to form the core-shell structure having a large zirconium concentration gradient.

In addition, by adjusting the firing conditions such as the particle size of the barium titanate powder in the dielectric material, the firing temperature, and the firing time, the median diameter of the crystal grains 17 in the dielectric layer 11 in the capacity section 14 obtained after firing can be adjusted.

### Re-Oxidation Process

In order to return oxygen to the barium titanate, which is the partially reduced main phase of the dielectric layer 11 fired in a reducing atmosphere, heat treatment may be performed in a mixed gas of N₂ and water vapor at about 1000° C. or in the air at 500° C. to 700° C. to the extent that the internal electrode layers 12 are not oxidized. This step is called a re-oxidation process.

### Plating Process (S5)

After that, metal layers such as Cu, Ni, Sn or the like may be formed on the base layers of the external electrodes 20a and 20b by plating. With the processes, the multilayer ceramic capacitor 100 is fabricated.

### EXAMPLES

The multilayer ceramic capacitors in accordance with the embodiment were made. And, property of the multilayer ceramic capacitors was measured.

(Example 1) Barium titanate, ZrO₂, rare earth oxides, MnCO₃, SrCO₃, CaCO₃, SiO₂, and an organic solvent were weighed so as to have a predetermined ratio, and mixed and pulverized with ϕ0.5 mm zirconia beads. The amount of zirconium with respect to titanium in barium titanate (Zr/Ti) was set to 4 at %. The amount of europium with respect to titanium (Eu/Ti) was set to 1 at %. The amount of manganese with respect to titanium was set to 1 at %. The amount of strontium with respect to titanium was set to 1 at %. No rare earth elements were added except europium.

A slurry obtained by adding a binder was applied to a ceramic green sheet, an internal electrode pattern was printed with Ni paste, stacked, and cut into a 1005 shape to produce a 1005-shaped ceramic multilayer structure. The ceramic multilayer structure was heated to 1230° C. at a temperature elevation rate of 6000° C./h, and high-speed firing was performed. For the purpose of reducing oxygen vacancies caused by reduction firing, the fired multilayer ceramic capacitor was subjected to re-oxidation treatment at 1000° C. in a nitrogen atmosphere.

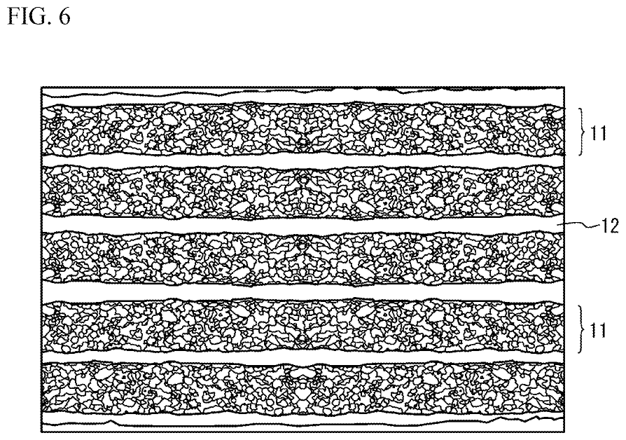

The thickness of the dielectric layer after firing was 2.0 μm. The thickness of the dielectric layer was determined by polishing with a polishing machine so that the cross section illustrated in FIG. 6 appeared, taking a SEM (Scanning Electron Microscope) of the cross section, measuring thicknesses of 20 points of five visual fields, and calculating an average thickness of the total of 100 points. As illustrated in FIG. 6, the crystal grain size was substantially uniform in the dielectric layer 11 in the capacity section. It is considered that this was because abnormal grain growth was suppressed by setting the amount of zirconium with respect to titanium to 2 at % or more and 10 at % or less.

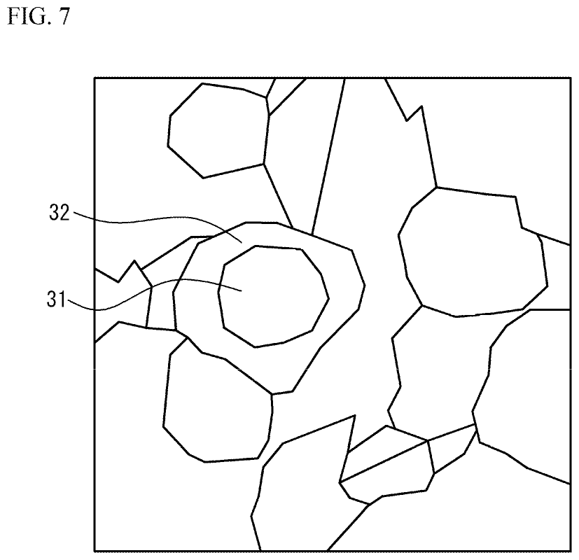

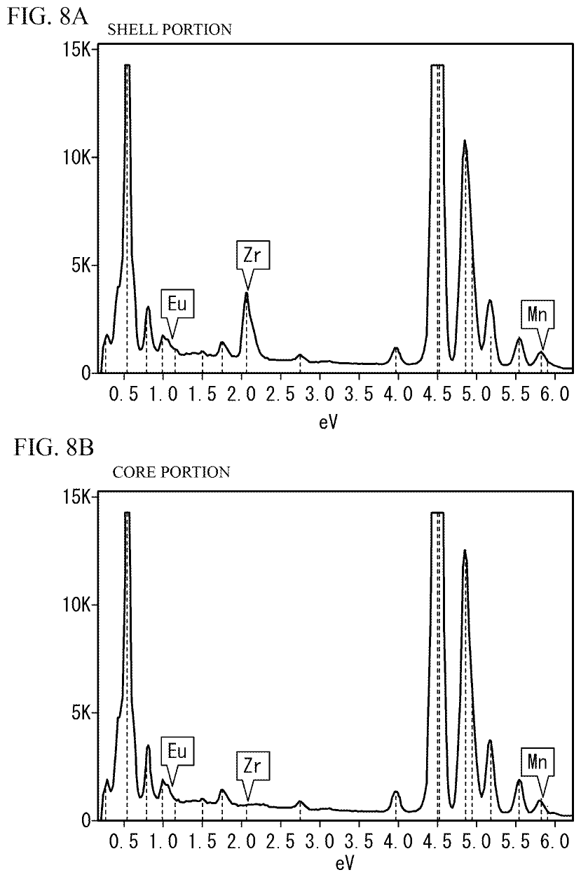

FIG. 7 is a TEM (Transmission Electron Microscope) image of the dielectric layer in the capacity section. As illustrated in FIG. 7, the core portion 31 and the shell portion 32 covering the core portion 31 were confirmed in the dielectric layer in the capacity section after firing. FIG. 8A illustrates measurement results of TEM-EDS (Energy Dispersive X-ray Spectroscopy) analysis of the shell portion 32. FIG. 8B illustrates the measurement results of TEM-EDS analysis for the core portion 31. As illustrated in FIG. 8A and FIG. 8B, it can be seen that the zirconium concentration is higher in the shell portion 32 than in the core portion 31. Europium was also confirmed in the core portion 31.

The X8R characteristics were measured in the range from −55° C. to 150° C. at 1 kHz and 1 Vrms. The dielectric constant was calculated from the dielectric thickness and the electrode area from the capacity at 25° C. The lifetime was evaluated by testing 10 samples at a high temperature and high electric field of 150° C. and 50 V/μm until all of them failed, and the average time was taken as the lifetime value. Table 2, Table 3 and Table 4 show the results of the accelerated life test and the determination results of the X8R characteristics. As for the accelerated life, 3000 min or more was judged to be acceptable “o”, and less than 3000 minutes was judged to be unacceptable “x”. As for the temperature characteristic, it was judged as “good” when the X8R characteristic was satisfied, and it was judged as “poor” when the X8R characteristic was not satisfied. If these two items were passed, the comprehensive evaluation was made “O”, and if even one item failed, the comprehensive judgment was made “X”.

For Example 1, the comprehensive judgment was judged as “good”. This is because the dielectric layer 11 in the capacity section contained barium titanate as the main component, the first additive containing zirconium in an amount of 2 at % or more and 10 at % or less with respect to titanium of barium titanate, the second additive containing 0.2 at % or more and 3.5 at % or less of europium with respect to titanium of barium titanate, the third additive containing 0.5 at % or more and 4.5 at % or less of manganese with respect to titanium of barium titanate, and the fourth additive containing at least one of strontium and calcium in an amount of 0.1 at % or more and 3 at % or less with respect to titanium in barium titanate, thereby achieving both long life and excellent capacity-temperature characteristics. The same result was obtained even if same amount of calcium was used instead of strontium.

(Comparative Example 1) In Comparative Example 1, ytterbium was used instead of europium. Other conditions were the same as in Example 1.

(Comparative Example 2) In Comparative Example 2, holmium was used instead of europium. Other conditions were the same as in Example 1.

(Comparative Example 3) In Comparative Example 3, dysprosium was used instead of europium. Other conditions were the same as in Example 1.

(Comparative Example 4) In Comparative Example 4, terbium was used instead of europium. Other conditions were the same as in Example 1.

(Comparative Example 5) In Comparative Example 5, gadolinium was used instead of europium. Other conditions were the same as in Example 1.

(Comparative Example 6) In Comparative Example 6, neodymium was used instead of europium. Other conditions were the same as in Example 1.

(Comparative Example 7) In Comparative Example 7, praseodymium was used instead of europium. Other conditions were the same as in Example 1.

(Comparative Example 8) In Comparative Example 8, cerium was used instead of europium. Other conditions were the same as in Example 1.

(Comparative Example 9) In Comparative Example 9, lanthanum was used instead of europium. Other conditions were the same as in Example 1.

For Comparative Examples 1 to 9, the accelerated life and X8R characteristics were measured in the same manner as in Example 1, and a comprehensive judgment was made. In all of Comparative Examples 1 to 9, the accelerated life was judged to be “bad”. It is considered that this was because rare earth elements other than europium were used. Moreover, none of Comparative Examples 2 to 9 satisfied the X8R characteristics. This is also considered to be due to the use of rare earth elements other than europium. The same results were obtained for Comparative Examples 1-9 when the same amount of calcium was used instead of strontium.

(Comparative Example 10) In Comparative Example 10, the amount of zirconium with respect to titanium was set to 0.5 at %. Other conditions were the same as in Example 1.

(Comparative Example 11) In Comparative Example 11, the amount of zirconium with respet to titanium was 1 at %. Other conditions were the same as in Example 1.

(Example 2) In Example 2, the amount of zirconium with respect to titanium was set to 2 at %. Other conditions were the same as in Example 1.

(Example 3) In Example 3, the amount of zirconium with respect to titanium was set to 6 at %. Other conditions were the same as in Example 1.

(Example 4) In Example 4, the amount of zirconium with respect to titanium was set to 8 at %. Other conditions were the same as in Example 1.

(Example 5) In Example 5, the amount of zirconium with respect to titanium was set to 10 at %. Other conditions were the same as in Example 1.

(Comparative Example 12) In Comparative Example 12, the amount of zirconium with respect to titanium was set to 20 at %. Other conditions were the same as in Example 1.

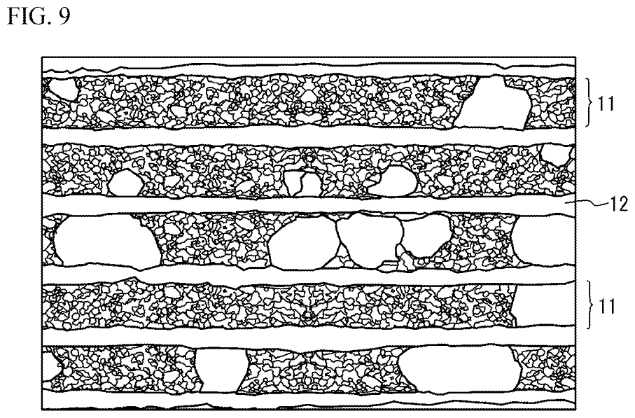

For Examples 2 to 5 and Comparative Examples 10 to 12, the accelerated life and X8R characteristics were measured in the same manner as in Example 1, and a comprehensive judgment was made. In Examples 2 to 5, the comprehensive judgment was judged to be “good”. This is because the dielectric layer 11 in the capacity section contained barium titanate as the main component, the first additive containing zirconium in an amount of 2 at % or more and 10 at % or less with respect to titanium of barium titanate, the second additive containing 0.2 at % or more and 3.5 at % or less of europium with respect to titanium of barium titanate, the third additive containing 0.5 at % or more and 4.5 at % or less of manganese with respect to titanium of barium titanate, and the fourth additive containing at least one of strontium and calcium in an amount of 0.1 at % or more and 3 at % or less with respect to titanium in barium titanate, thereby achieving both long life and excellent capacity-temperature characteristics. The same result was obtained even if same amount of calcium was used instead of strontium. On the other hand, in Comparative Examples 10 and 11, the accelerated life was judged to be “bad”. This is because the core-shell structure described in FIG. 4A and FIG. 4B could not be achieved and local abnormal grain growth did not achieve life time because the amount of the added zirconium was small. FIG. 9 is an SEM image of a multilayer cross-section of the dielectric layer 11 and the internal electrode layer 12 in the capacitor section in Comparative Example 11. As illustrated in FIG. 9, it was confirmed that abnormal grain growth occurred in the dielectric layer in the capacitor section. In Comparative Example 13, the temperature characteristic was judged to be “bad”. This is probably because the amount of added zirconium was large. The same results were obtained even if the same amount of calcium was used instead of strontium for Examples 2-4 and Comparative Examples 10-13.

(Comparative Example 13) In Comparative Example 13, the amount of europium with respect to titanium was set to 0.05 at %. Other conditions were the same as in Example 1.

(Comparative Example 14) In Comparative Example 14, the amount of europium with respect to titanium was set to 0.1 at %. Other conditions were the same as in Example 1.

(Example 6) In Example 6, the amount of europium with respect to titanium was set to 0.5 atomic %. Other conditions were the same as in Example 1.

(Example 7) In Example 7, the amount of europium with respect to titanium was set to 2 at %. Other conditions were the same as in Example 1.

(Example 8) In Example 8, the amount of europium with respect to titanium was set to 3 at %. Other conditions were the same as in Example 1.

(Comparative Example 15) In Comparative Example 15, the amount of europium with respect to titanium was set to 4 at %. Other conditions were the same as in Example 1.

For Examples 6 to 8 and Comparative Examples 13 to 15, the accelerated life and X8R characteristics were measured in the same manner as in Example 1, and a comprehensive judgment was made. In Examples 6 to 8, the comprehensive judgment was judged to be “good”. This is because the dielectric layer 11 in the capacity section contained barium titanate as the main component, the first additive containing zirconium in an amount of 2 at % or more and 10 at % or less with respect to titanium of barium titanate, the second additive containing 0.2 at % or more and 3.5 at % or less of europium with respect to titanium of barium titanate, the third additive containing 0.5 at % or more and 4.5 at % or less of manganese with respect to titanium of barium titanate, and the fourth additive containing at least one of strontium and calcium in an amount of 0.1 at % or more and 3 at % or less with respect to titanium in barium titanate, thereby achieving both long life and excellent capacity-temperature characteristics. On the other hand, in Comparative Examples 14 and 15, the accelerated life was judged to be “bad”. It is considered that this was because the amount of europium added was small and the life was not sufficiently extended. Also in Comparative Example 16, the accelerated life was judged to be “bad”. This is probably because the amount of added europium was large, the dielectric layer became semiconductor and the sufficient long life was not obtained. The same results were obtained even if the same amount of calcium was used instead of strontium for Examples 6-8 and Comparative Examples 13-15.

(Comparative Example 16) In Comparative Example 16, the amount of manganese with respect to titanium was set to 0.1 at %. Other conditions were the same as in Example 1.

(Example 9) In Example 9, the amount of manganese with respect to titanium was set to 0.5 at %. Other conditions were the same as in Example 1.

(Example 10) In Example 10, the amount of manganese with respect to titanium was set to 2 at %. Other conditions were the same as in Example 1.

(Example 11) In Example 11, the amount of manganese with respect to titanium was set to 3 at %. Other conditions were the same as in Example 1.

(Comparative Example 17) In Comparative Example 17, the amount of manganese with respect to titanium was set to 5 at %. Other conditions were the same as in Example 1.

(Comparative Example 18) In Comparative Example 18, the amount of manganese with respect to titanium was set to 10 at %. Other conditions were the same as in Example 1.

For Examples 9 to 11 and Comparative Examples 16 to 18, the accelerated life and X8R characteristics were measured in the same manner as in Example 1, and a comprehensive judgment was made. In Examples 8 to 10, the comprehensive judgment was judged to be “good”. This is because the dielectric layer 11 in the capacity section contained barium titanate as the main component, the first additive containing zirconium in an amount of 2 at % or more and 10 at % or less with respect to titanium of barium titanate, the second additive containing 0.2 at % or more and 3.5 at % or less of europium with respect to titanium of barium titanate, the third additive containing 0.5 at % or more and 4.5 at % or less of manganese with respect to titanium of barium titanate, and the fourth additive containing at least one of strontium and calcium in an amount of 0.1 at % or more and 3 at % or less with respect to titanium in barium titanate, thereby achieving both long life and excellent capacity-temperature characteristics. On the other hand, in Comparative Example 17, the accelerated life was judged to be “bad”. It is considered that this was because the dielectric layer became a semiconductor due to lack of acceptors. Also in Comparative Examples 17 and 18, the accelerated life was judged to be “bad”. It is considered that this was because there was an excess of acceptors. The same results were obtained for Examples 9-11 and Comparative Examples 16-18 even if the same amount of calcium was used instead of strontium.

(Comparative Example 19) In Comparative Example 19, the amount of strontium with respect to titanium was set to 0.05 at %. Other conditions were the same as in Example 1.

(Example 12) In Example 12, the amount of strontium with respect to titanium was set to 0.1 at %. Other conditions were the same as in Example 1.

(Example 13) In Example 13, the amount of strontium with respect to titanium was set to 0.3 at %. Other conditions were the same as in Example 1.

(Example 14) In Example 14, the amount of strontium with respect to titanium was set to 0.5 at %. Other conditions were the same as in Example 1.

(Comparative Example 20) In Comparative Example 20, the amount of strontium with respect to titanium was set to 5 at %. Other conditions were the same as in Example 1.

(Comparative Example 21) In Comparative Example 21, the amount of strontium with respect to titanium was set to 10 at %. Other conditions were the same as in Example 1.

For Examples 12 to 14 and Comparative Examples 19 to 21, the accelerated life and X8R characteristics were measured in the same manner as in Example 1, and a comprehensive judgment was made. In Examples 12 to 14, the comprehensive judgment was judged to be “good”. This is because the dielectric layer 11 in the capacity section contained barium titanate as the main component, the first additive containing zirconium in an amount of 2 at % or more and 10 at % or less with respect to titanium of barium titanate, the second additive containing 0.2 at % or more and 3.5 at % or less of europium with respect to titanium of barium titanate, the third additive containing 0.5 at % or more and 4.5 at % or less of manganese with respect to titanium of barium titanate, and the fourth additive containing at least one of strontium and calcium in an amount of 0.1 at % or more and 3 at % or less with respect to titanium in barium titanate, thereby achieving both long life and excellent capacity-temperature characteristics. On the other hand, in Comparative Example 19, the X8R characteristics was judged to be “bad”. This is probably because the amount of added strontium was small. The accelerated life of Comparative Examples 20 and 21 was judged to be “bad”. This is probably because the amount of added strontium added was large and grain growth occurred. The same results were obtained for Examples 12-14 and Comparative Examples 19-21 even if the same amount of calcium was used instead of strontium.

(Comparative Example 22) In Comparative Example 22, 1 at % of holmium with respect to titanium was added to the conditions of Example 1.

For Comparative Example 22, the accelerated life and X8R characteristics were measured in the same manner as in Example 1, and a comprehensive judgment was made. In Comparative Example 22, both accelerated life and temperature characteristics were judged to be “bad”. This is probably because europium was not contained in a larger amount than rare earth elements other than europium.

TABLE 2

| | | RARE | | | | | | |
|---|---|---|---|---|---|---|---|---|
| | | EARTH | | | Sr/Ti | | | |
| | | ELEMENT/ | | | or | LIFE | | |
| | Zr/Ti | Ti | | Mn/Ti | Ca/Ti | TIME | | COMPREHENSIVE |
| | (at %) | (at %) | | (at %) | (at %) | (min) | X8R | EVALUATION |
| EXAMPLE 1 | 4 | Eu | 1 | 1 | 1 | 3000 | ◯ | ◯ |
| COMPARATIVE | 4 | Yb | 1 | 1 | 1 | 300 | ◯ | X |
| EXAMPLE 1 | | | | | | | | |
| COMPARATIVE | 4 | Ho | 1 | 1 | 1 | 250 | X | X |
| EXAMPLE 2 | | | | | | | | |
| COMPARATIVE | 4 | Dy | 1 | 1 | 1 | 350 | X | X |
| EXAMPLE 3 | | | | | | | | |
| COMPARATIVE | 4 | Tb | 1 | 1 | 1 | 300 | X | X |
| EXAMPLE 4 | | | | | | | | |
| COMPARATIVE | 4 | Gd | 1 | 1 | 1 | 150 | X | X |
| EXAMPLE 5 | | | | | | | | |
| COMPARATIVE | 4 | Nd | 1 | 1 | 1 | 0 | X | X |
| EXAMPLE 6 | | | | | | | | |
| COMPARATIVE | 4 | Pr | 1 | 1 | 1 | 0 | X | X |
| EXAMPLE 7 | | | | | | | | |
| COMPARATIVE | 4 | Ce | 1 | 1 | 1 | 20 | X | X |
| EXAMPLE 8 | | | | | | | | |
| COMPARATIVE | 4 | La | 1 | 1 | 1 | 50 | X | X |
| EXAMPLE 9 | | | | | | | | |

TABLE 3

| | | RARE | | | | | | |
|---|---|---|---|---|---|---|---|---|
| | | EARTH | | | Sr/Ti | | | |
| | | ELEMENT/ | | | or | LIFE | | |
| | Zr/Ti | Ti | | Mn/Ti | Ca/Ti | TIME | | COMPREHENSIVE |
| | (at %) | (at %) | | (at %) | (at %) | (min) | X8R | EVALUATION |
| COMPARATIVE | 0.5 | Eu | 1 | 1 | 1 | 100 | ◯ | X |
| EXAMPLE 10 | | | | | | | | |
| COMPARATIVE | 1 | Eu | 1 | 1 | 1 | 100 | ◯ | X |
| EXAMPLE 11 | | | | | | | | |
| EXAMPLE 2 | 2 | Eu | 1 | 1 | 1 | 3000 | ◯ | ◯ |
| EXAMPLE 3 | 6 | Eu | 1 | 1 | 1 | 3500 | ◯ | ◯ |
| EXAMPLE 4 | 8 | Eu | 1 | 1 | 1 | 3500 | ◯ | ◯ |
| EXAMPLE 5 | 10 | Eu | 1 | 1 | 1 | 3500 | ◯ | ◯ |
| COMPARATIVE | 20 | Eu | 1 | 1 | 1 | 4000 | X | X |
| EXAMPLE 12 | | | | | | | | |
| COMPARATIVE | 4 | Eu | 0.05 | 1 | 1 | 500 | X | X |
| EXAMPLE 13 | | | | | | | | |
| COMPARATIVE | 4 | Eu | 0.1 | 1 | 1 | 1200 | ◯ | X |
| EXAMPLE 14 | | | | | | | | |
| EXAMPLE 6 | 4 | Eu | 0.5 | 1 | 1 | 3000 | ◯ | ◯ |
| EXAMPLE 7 | 4 | Eu | 2 | 1 | 1 | 3300 | ◯ | ◯ |
| EXAMPLE 8 | 4 | Eu | 3 | 1 | 1 | 3500 | ◯ | ◯ |
| COMPARATIVE | 4 | Eu | 4 | 1 | 1 | 1000 | ◯ | X |
| EXAMPLE 15 | | | | | | | | |

TABLE 4

| | | RARE | | | | | | |
|---|---|---|---|---|---|---|---|---|
| | | EARTH | | | Sr/Ti | | | |
| | | ELEMENT/ | | | or | LIFE | | |
| | Zr/Ti | Ti | | Mn/Ti | Ca/Ti | TIME | | COMPREHENSIVE |
| | (at %) | (at %) | | (at %) | (at %) | (min) | X8R | EVALUATION |
| COMPARATIVE | 4 | Eu | 1 | 0.1 | 1 | 500 | X | X |
| EXAMPLE 16 | | | | | | | | |
| EXAMPLE 9 | 4 | Eu | 1 | 0.5 | 1 | 3000 | ◯ | ◯ |
| EXAMPLE 10 | 4 | Eu | 1 | 2 | 1 | 3500 | ◯ | ◯ |
| EXAMPLE 11 | 4 | Eu | 1 | 3 | 1 | 4000 | ◯ | ◯ |
| COMPARATIVE | 4 | Eu | 1 | 5 | 1 | 2000 | X | X |
| EXAMPLE 17 | | | | | | | | |
| COMPARATIVE | 4 | Eu | 1 | 10 | 1 | 200 | X | X |
| EXAMPLE 18 | | | | | | | | |
| COMPARATIVE | 4 | Eu | 1 | 1 | 0.05 | 3000 | X | X |
| EXAMPLE 19 | | | | | | | | |
| EXAMPLE 12 | 4 | Eu | 1 | 1 | 0.1 | 3000 | ◯ | ◯ |
| EXAMPLE 13 | 4 | Eu | 1 | 1 | 0.3 | 3500 | ◯ | ◯ |
| EXAMPLE 14 | 4 | Eu | 1 | 1 | 0.5 | 3500 | ◯ | ◯ |
| COMPARATIVE | 4 | Eu | 1 | 1 | 5 | 300 | X | X |
| EXAMPLE 20 | | | | | | | | |
| COMPARATIVE | 4 | Eu | 1 | 1 | 10 | 0 | X | X |
| EXAMPLE 21 | | | | | | | | |
| COMPARATIVE | 4 | Eu/Ho | 1/1 | 1 | 1 | 100 | X | X |
| EXAMPLE 22 | | | | | | | | |

Although the embodiments of the present invention have been described in detail, it is to be understood that the various change, substitutions, and alterations could be made hereto without departing from the spirit and scope of the invention.

What is claimed is:

1. A dielectric material comprising:
a main component including barium titanate;
a first additive containing zirconium in an amount of 2 at % or more and 10 at % or less with respect to titanium of the barium titanate;
a second additive containing 0.2 at % or more and 3.5 at % or less of europium with respect to titanium of the barium titanate, rare earth elements other than europium being less than europium;
a third additive containing 0.5 at % or more and 4.5 at % or less of manganese with respect to titanium of the barium titanate; and
a fourth additive containing at least one of strontium and calcium in an amount of 0.1 at or more and 3 at % or less with respect to titanium in the barium titanate.

2. The dielectric material as claimed in claim 1 further comprising:
a dielectric crystal having a core portion in which europium is solid-dissolved and a shell portion covering the core portion and having a higher zirconium concentration than the core portion.

3. The dielectric material as claimed in claim 1, wherein the second additive contains divalent europium and trivalent europium, and the divalent europium accounts for 21% or more and 80% or less of a total europium contained in the second additive.

4. The dielectric material as claimed in claim 1, wherein the first additive contains 2 at % or more and 8 at % or less of zirconium with respect to titanium in the barium titanate.

5. The dielectric material as claimed in claim 1, wherein the second additive contains 0.5 at % or more and 3 at % or less of europium with respect to titanium in the barium titanate.

6. The dielectric material as claimed in claim 1, wherein the third additive contains 0.5 at % or more and 3 at % or less of manganese with respect to titanium in the barium titanate.

7. The dielectric material as claimed in claim 1, wherein the fourth additive contains at least one of strontium and calcium in an amount of 0.1 at % or more and 1 at % or less of titanium in the barium titanate.

8. A multilayer ceramic electronic device comprising:
a plurality of dielectric layers including a main component including barium titanate, a first additive containing zirconium in an amount of 2 at % or more and 10 at % or less with respect to titanium of the barium titanate, a second additive containing 0.2 at % or more and 3.5 at % or less of europium with respect to titanium of the barium titanate, rare earth elements other than europium being less than europium, a third additive containing 0.5 at % or more and 4.5 at % or less of manganese with respect to titanium of the barium titanate, and a fourth additive containing at least one of strontium and calcium in an amount of 0.1 at % or more and 3 at % or less with respect to titanium in the barium titanate;
a plurality of internal electrode layers each of which is sandwiched by each two of the plurality of dielectric layers; and
external electrodes that are electrically connected to the plurality of internal electrode layers.

9. The multilayer ceramic electronic device as claimed in claim 8, wherein the plurality of dielectric layers include a dielectric crystal having a core portion in which europium is solid-dissolved and a shell portion covering the core portion and having a higher zirconium concentration than the core portion.

10. The multilayer ceramic electronic device as claimed in claim 8, wherein the second additive contains divalent europium and trivalent europium, and the divalent europium accounts for 21% or more and 80% or less of a total europium contained in the second additive.

11. The multilayer ceramic electronic device as claimed in claim 8, wherein the first additive contains 2 at % or more and 8 at % or less of zirconium with respect to titanium in the barium titanate.

12. The multilayer ceramic electronic device as claimed in claim 8, wherein the second additive contains 0.5 at % or more and 3 at % or less of europium with respect to titanium in the barium titanate.

13. The multilayer ceramic electronic device as claimed in claim 8, wherein the third additive contains 0.5 at % or more and 3 at % or less of manganese with respect to titanium in the barium titanate.

14. The multilayer ceramic electronic device as claimed in claim 8, wherein the fourth additive contains at least one of strontium and calcium in an amount of 0.1 at % or more and 1 at % or less of titanium in the barium titanate.

15. The multilayer ceramic electronic device as claimed in claim 8, wherein the multilayer ceramic electronic device satisfies X8R characteristic.

16. A manufacturing method of a dielectric material comprising:
forming a ceramic green sheet including a main component including barium titanate, a first additive containing zirconium in an amount of 2 at % or more and 10 at % or less with respect to titanium of the barium titanate, a second additive containing 0.2 at % or more and 3.5 at % or less of europium with respect to titanium of the barium titanate, rare earth elements other than europium being less than europium, a third additive containing 0.5 at % or more and 4.5 at % or less of manganese with respect to titanium of the barium titanate, and a fourth additive containing at least one of strontium and calcium in an amount of 0.1 at % or more and 3 at % or less with respect to titanium in the barium titanate; and
firing the ceramic green sheet at a temperature rising rate of 5000° C./h or more and 10000° C./h or less.

17. A manufacturing method of a multilayer ceramic electronic device comprising:
forming a plurality of ceramic green sheets including a main component including barium titanate, a first additive containing zirconium in an amount of 2 at % or more and 10 at % or less with respect to titanium of the barium titanate, a second additive containing 0.2 at % or more and 3.5 at % or less of europium with respect to titanium of the barium titanate, rare earth elements other than europium being less than europium, a third additive containing 0.5 at % or more and 4.5 at % or less of manganese with respect to titanium of the barium titanate, and a fourth additive containing at least one of strontium and calcium in an amount of 0.1 at % or more and 3 at % or less with respect to titanium in the barium titanate;
forming an internal electrode pattern on each of the ceramic green sheets;
forming a multilayer structure by stacking the plurality of ceramic green sheets on which the internal electrode is formed; and
forming a plurality of dielectric layers and a plurality of internal electrode layers by firing the multilayer structure at a temperature rising rate of 5000° C./h or more and 10000° C./h or less.

18. The method as claimed in claim 17 further comprising:
performing a re-oxidation process by thermally treating the plurality of dielectric layers and the plurality of internal electrode layers after the firing.
